(19) United States
(12) Patent Application Publication
(10) Pub. No.: US 2020/0383365 A1
(43) Pub. Date: Dec. 10, 2020

(54) MAYONNAISE POWDER COMPOSITION AND METHOD OF MAKING A FOOD PRODUCT USING THE SAME

(71) Applicants: SAYEDALIREZA MOOSAVI, Frankfurt (DE); POUYA MOLANA, Frankfurt (DE)

(72) Inventors: SAYEDALIREZA MOOSAVI, Frankfurt (DE); POUYA MOLANA, Frankfurt (DE)

(21) Appl. No.: 16/895,930

(22) Filed: Jun. 8, 2020

(51) Int. Cl. A23L 27/60; A23L 23/00; A23L 29/30; A23L 29/212; A23L 29/238; A23L 29/269; A23L 29/256; A23L 29/281; A23L 27/40; A23L 29/00; A23L 29/262; A23L 27/16; A23L 27/18; C12J 1/00

(52) U.S. Cl. CPC A23L 27/66; A23V 2002/00; A23L 29/30; A23L 29/212; A23L 29/238; A23L 29/27; A23L 29/256; A23L 29/284; A23L 27/40; A23L 29/035; A23L 29/262; A23L 27/16; A23L 27/18; C12J 1/00; A23L 23/00

(57) ABSTRACT

A mayonnaise powder composition and a method of making a food product such as a sauce using the mayonnaise powder is disclosed. The mayonnaise powder composition comprises a predetermined quantity of a stabilizer, a sugar, a citric acid, a salt, and a spice. The proposed invention also discloses the composition of the stabilizer with a predetermined quantity. The method of preparing the sauce by the said mayonnaise powder composition comprises the step of introducing and mixing one or more ingredients in the mayonnaise powder with predetermined quantity. The mayonnaise powder composition facilitates the simple and inexpensive process of producing mayonnaise at home, and reduces the cost of production in large scale industries. The mayonnaise powder according to the present invention, is made of natural ingredients, and contains no chemical/artificial preservatives.

### TECHNICAL FIELD OF THE INVENTION

The invention disclosed herein generally relates to food technology and industry. More particularly, the invention relates to a food powder composition of the mayonnaise, and a method for making mayonnaise related product such as sauce, etc. using the same.

### BACKGROUND

Mayonnaise sauce is an egg yolk and oil emulsion, and to which flavor could be added with vinegar, lemon juice, mustard, salt, or pepper. For preparing the sauce, the egg yolks must be constantly stirred in the same direction by an electronic beater, while the oil is incorporated first using a large-scale kitchen/cooking appliances, drop by drop and then in a fine trickle to avoid the mix from clumping. Once well blended, the sauce is flavored with the rest of the ingredients, for example, in one blend, the proportion could be one glass of oil for each egg yolk, 2 or 3 spoon of vinegar, mustard and salt to taste.

Generally, the mayonnaise sauce is usually being produced in large scale using advanced equipment and technology, where preparing mayonnaise at home is not common. The preparation of the mayonnaise sauce at home is a challenging task, because there is a requirement for adding many ingredients, such as different types of food flavors and stabilizers. There is also a need for planning different proportions of its ingredients to provide good taste and better stability. Further, the mayonnaise preparation requires strong mixers to make a stable emulsion. Moreover, there is also a need for adding chemical preservatives such as, sodium benzoate and potassium sorbate, to increase the time of storage.

Hence, there is a long felt but unresolved need for home-made powder formulation or composition of mayonnaise product. There is also a need in the art for producing mayonnaise powder formula to prepare mayonnaise in the short duration, in low price, and with an acceptable texture, taste, and stability. Therefore, there is a need in the art for preparing mayonnaise in an easy way without using any known expensive and advanced equipment.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention relates to a mayonnaise powder composition and a method of preparing a mayonnaise sauce by the said mayonnaise powder composition. In one aspect, the said powder composition comprises stabilizer ranges from 10% to 30% by weight, sugar ranges from 40% to 60% by weight, citric acid ranges from 2% to 8% by weight, salt ranges from 5% to 15% by weight, and spice ranges from 5% to 15% by weight. In another aspect, the composition further comprises stabilizer of 20% by weight, sugar of 50% by weight, citric acid of 5% by weight, salt of 15% by weight, and spice of 10% by weight. The stabilizer according to the present invention, is a mayonnaise stabilizer. The spice is a mustard, a garlic, or an onion powder.

In one aspect, the stabilizer in the mayonnaise powder composition comprises, a modified starch ranges from 15% to 30% by weight, a milk protein ranges from 10% to 30% by weight, a guar gum ranges from 5% to 15% by weight, a xanthan gum ranges from 5% to 15% by weight, a propylene glycol alginate ranges from 2% to 8% by weight, a locust bean gum ranges from 2% to 8% by weight, a tara gum ranges from 2% to 8% by weight, a carboxymethyl cellulose ranges from 2% to 8% by weight, a gelatin ranges from 2% to 8% by weight, and a soy protein ranges from 2% to 8% by weight.

In another aspect, the stabilizer in the mayonnaise powder composition comprises, modified starch of 25% by weight, milk protein of 20% by weight, guar gum of 10% by weight, xanthan gum of 10% by weight, a propylene glycol alginate of 10% by weight, a locust bean gum of 5% by weight, tara gum ranges of 5% by weight, carboxymethyl cellulose of 5% by weight, gelatin ranges of 5% by weight, and soy protein ranges of 5% by weight.

In an aspect, the present invention also relates to a method of preparing a mayonnaise sauce by the said mayonnaise powder composition. In one step, the mayonnaise powder is introduced to one or more ingredients in a container. In another step, the said ingredients in the mayonnaise powder are mixed with predetermined quantity to produce the mayonnaise sauce. The ingredients are water, oil, and vinegar. In another aspect, the said ingredients are mixed in the mayonnaise powder with predetermined quantity comprises, 45% of water, 30% of oil, 10% of vinegar, and 15% of mayonnaise powder to produce the mayonnaise sauce.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a method of preparing a mayonnaise sauce by using a mayonnaise powder composition.

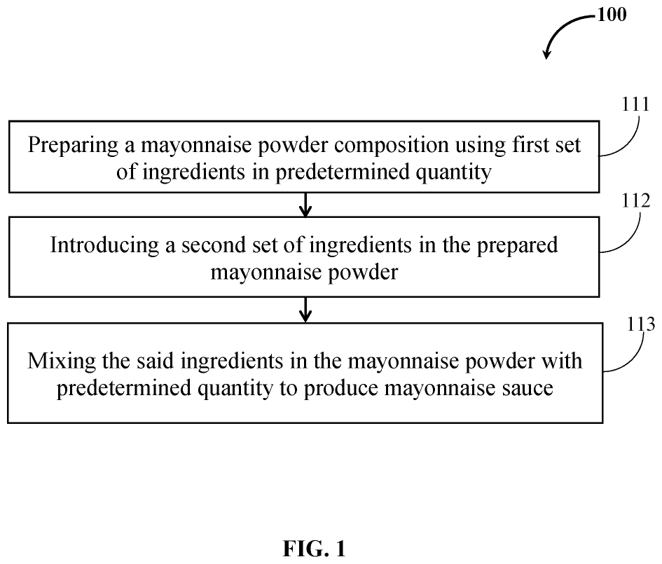

### DETAILED DESCRIPTION OF THE INVENTION

A description of embodiments of the present invention will now be given with reference to the FIGURES. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to a mayonnaise powder composition and a method 100 of preparing a mayonnaise sauce by the said mayonnaise powder composition. In an embodiment, the mayonnaise powder composition comprises a predetermined quantity of a stabilizer, a sugar, a citric acid, a salt, and a spice. The stabilizer according to the present invention, is a mayonnaise stabilizer. In one embodiment, the spice could be any flavored spice, which is not limited to a mustard, a garlic, or an onion powder.

In one embodiment, the said powder composition comprises stabilizer ranges from 10% to 30% by weight, sugar ranges from 40% to 60% by weight, citric acid ranges from 2% to 8% by weight, salt ranges from 5% to 15% by weight, and spice ranges from 5% to 15% by weight. In another embodiment, the composition further comprises stabilizer of 20% by weight, sugar of 50% by weight, citric acid of 5% by weight, salt of 15% by weight, and spice of 10% by weight.

In an embodiment, the stabilizer in the mayonnaise powder composition comprises, a modified starch ranges, a milk protein, a guar gum, a xanthan gum, a propylene glycol alginate, a locust bean gum, a tara gum, a carboxymethyl cellulose, a gelatin, and a soy protein.

In one embodiment, the stabilizer in the mayonnaise powder composition comprises, a modified starch ranges from 15% to 30% by weight, a milk protein ranges from 10% to 30% by weight, a guar gum ranges from 5% to 15% by weight, a xanthan gum ranges from 5% to 15% by weight, a propylene glycol alginate ranges from 2% to 8% by weight, a locust bean gum ranges from 2% to 8% by weight, a tara gum ranges from 2% to 8% by weight, a carboxymethyl cellulose ranges from 2% to 8% by weight, a gelatin ranges from 2% to 8% by weight, and a soy protein ranges from 2% to 8% by weight.

In another embodiment, the stabilizer in the mayonnaise powder composition comprises, modified starch of 25% by weight, milk protein of 20% by weight, guar gum of 10% by weight, xanthan gum of 10% by weight, a propylene glycol alginate of 10% by weight, a locust bean gum of 5% by weight, tara gum ranges of 5% by weight, carboxymethyl cellulose of 5% by weight, gelatin ranges of 5% by weight, and soy protein ranges of 5% by weight.

In an embodiment, the present invention also relates to a method 100 of preparing a mayonnaise sauce by the said mayonnaise powder composition. In step 111, the mayonnaise powder composition is prepared by using a first set of ingredients in predetermined quantity. The first set of ingredients are mixed or stirred by using stirrer, or any related equipment at room temperature, to produce the mayonnaise powder. In one embodiment, the said first set of ingredients comprises a stabilizer, a sugar, a citric acid, a salt, and a spice. In another embodiment, the first set of ingredients comprises stabilizer of 20% by weight, sugar of 50% by weight, citric acid of 5% by weight, salt of 15% by weight, and spice of 10% by weight. The stabilizer is a mayonnaise stabilizer. The spice is a mustard, a garlic, or an onion powder.

In step 112, the mayonnaise powder is introduced to one or more second set of ingredients in a container. In one embodiment, the second set of ingredients are water, oil, and vinegar. In another embodiment, the said second set of ingredients are mixed in the mayonnaise powder with predetermined quantity comprises, 45% of water, 30% of oil, 10% of vinegar, and 15% of mayonnaise powder to produce the mayonnaise sauce.

In step 113, the said second set of ingredients in the mayonnaise powder are mixed with predetermined quantity to produce the mayonnaise sauce. In an embodiment, the said second set of ingredients in the mayonnaise powder are mixed by using a stirrer, or any related equipment. In another embodiment, the second set of ingredients in the mayonnaise powder are mixed with predetermined quantity at room temperature to produce the mayonnaise sauce.

The mayonnaise powder composition facilitates a simple and easy process of producing mayonnaise at home. The said powder formulation comprises necessary or customized, or all food flavors and stabilizers, so that it avoids the requirement of large range of ingredients. Further, the proportion of the powder formulation comprises different types of stabilizers that could be planned and customized in a way to provide the stable emulsion. The present invention provides a simple method of preparing mayonnaise by just stirring the powder formulation with specified amount of water and oil, so that it neglects the need for having advanced mixers.

The mayonnaise powder could be kept for a long time and occupies less space, for example, more than two years in a container, so the mayonnaise could be prepared instantly on requirement/use basis. Henceforth, there is no need for refrigeration, fast consumption in a fear of spoiling, and occupying too much space. The present invention further reduces the cost of production in industrial scales and also it could be easy to be used at home. The present invention also provides an option for choosing the amount of oil and its type by the consumer. Further, the mayonnaise powder according to the present invention, is made of natural foodstuffs and contains no chemical/artificial preservatives.

The foregoing examples have been provided merely for the purpose of explanation and are in no way to be construed as limiting of the powder composition, disclosed herein. While the powder composition has been described with reference to various embodiments, it is understood that the words, which have been used herein, are words of description and illustration, rather than words of limitation. Further, although the powder composition, has been described herein with reference to particular means, materials, and embodiments, the powder composition is not intended to be limited to the particulars disclosed herein; rather, the powder composition extends to all functionally equivalent structures, methods and uses, such as are within the scope of the appended claims. Those skilled in the art, having the benefit of the teachings of this specification, may effect numerous modifications thereto and changes may be made without departing from the scope and spirit of the powder composition disclosed herein in their aspects.

What is claimed is:

1. A mayonnaise powder composition, the composition comprising:
a stabilizer ranges from 10% to 30% by weight;
a sugar ranges from 40% to 60% by weight;
a citric acid ranges from 2% to 8% by weight;
a salt ranges from 5% to 15% by weight; and
a spice ranges from 5% to 15% by weight.

2. The composition of claim 1, comprising stabilizer of 20% by weight, sugar of 50% by weight, citric acid of 5% by weight, salt of 15% by weight, and spice of 10% by weight.

3. The composition of claim 1, wherein the stabilizer comprising:
a modified starch ranges from 15% to 30% by weight;
a milk protein ranges from 10% to 30% by weight;
a guar gum ranges from 5% to 15% by weight;
a xanthan gum ranges from 5% to 15% by weight;
a propylene glycol alginate ranges from 2% to 8% by weight;
a locust bean gum ranges from 2% to 8% by weight;
a tara gum ranges from 2% to 8% by weight;
a carboxymethyl cellulose ranges from 2% to 8% by weight;
a gelatin ranges from 2% to 8% by weight, and
a soy protein ranges from 2% to 8% by weight.

4. The composition of claim 1, wherein the stabilizer comprising modified starch of 25% by weight, milk protein of 20% by weight, guar gum of 10% by weight, xanthan gum of 10% by weight, propylene glycol alginate of 10% by weight, locust bean gum of 5% by weight, tara gum ranges of 5% by weight, carboxymethyl cellulose of 5% by weight, gelatin ranges of 5% by weight, and soy protein ranges of 5% by weight.

5. The composition of claim 1, wherein the stabilizer is a mayonnaise stabilizer.

6. The composition of claim 1, wherein the spice is a mustard, a garlic, or an onion powder.

7. A method of preparing a mayonnaise sauce by the said mayonnaise powder composition of claim 1, comprising:
introducing one or more ingredients in the mayonnaise powder, and
mixing the said ingredients in the mayonnaise powder with predetermined quantity to produce the mayonnaise sauce.

8. The method of claim 7, wherein the ingredients are water, oil, and vinegar.

9. The method of claim 7, wherein the mixing the said ingredients in the mayonnaise powder with predetermined quantity comprises 45% of water, 30% of oil, 10% of vinegar, and 15% of mayonnaise powder to produce the mayonnaise sauce.
